(19) United States
(12) Patent Application Publication
(10) Pub. No.: US 2013/0057495 A1
(43) Pub. Date: Mar. 7, 2013

(54) TOUCH DISPLAY PANEL

(71) Applicants: Wen-Chun Wang, Taichung City (TW); Kuo-Chang Su, Tainan City (TW); Chin-Chang Liu, Taichung County (TW); Chih-Jung Teng, Taichung City (TW)

(72) Inventors: Wen-Chun Wang, Taichung City (TW); Kuo-Chang Su, Tainan City (TW); Chin-Chang Liu, Taichung County (TW); Chih-Jung Teng, Taichung City (TW)

(73) Assignees: WINTEK CORPORATION, Taichung City (TW); WINTEK (CHINA) TECHNOLOGY LTD., Guangdong Province (CN)

(21) Appl. No.: 13/600,244

(22) Filed: Aug. 31, 2012

(30) Foreign Application Priority Data
Sep. 2, 2011 (TW) 100131757

(51) Int. Cl. G06F 3/041; G09G 3/30

(52) U.S. Cl. 345/173; 345/76

(57) ABSTRACT

A touch display panel including an organic electro-luminescent display panel, a cover plate, a touch sensing element, and a decoration layer is provided. The organic electro-luminescent display panel includes a carrier plate, a packing cover, and a plurality of organic light emitting units. The carrier plate and the packing cover are assembled to construct a sealed space. The organic light emitting units are disposed on the carrier plate and located inside the sealed space. The cover plate is adhered on a side of the carrier plate away from the organic light emitting units. The touch sensing element is disposed between the carrier plate of the organic electro-luminescent display panel and the cover plate. The decoration layer is disposed on the cover plate.

### CROSS-REFERENCE TO RELATED APPLICATION

This application claims the priority benefit of Taiwan application serial no. 100131757, filed on Sep. 2, 2011. The entirety of the above-mentioned patent application is hereby incorporated by reference herein and made a part of this specification.

### BACKGROUND OF THE INVENTION

1. Field of the Invention

The present invention generally relates to a touch display panel, and more particularly, to a touch display panel display images by using organic light emitting units.

2. Description of Related Art

In current information era, human beings by degrees tend to rely on electronic products. The electronic products such as mobile phones, handheld personal computers (PCs), personal digital assistants (PDAs) and smart phones have pervaded everywhere in our daily life. To meet current demands on portable, compact, and user-friendly information technology (IT) products, touch panels have been introduced as input devices in replacement of conventional keyboards or mice. Among the touch panels, a touch display panel capable of performing both a touch sensing function and a display function is one of the most popular products at present.

### SUMMARY OF THE INVENTION

The invention provides a touch display panel displaying images by organic light emitting units and having a touch sensing element fabricated directly on the cover plate, such that the touch display panel can have both the touch sensing function and the display function without largely increasing the thickness thereof.

The invention provides a touch display panel including an organic electro-luminescent display panel, a cover plate, a touch element, and a decoration layer. The organic electro-luminescent display panel includes a carrier plate, a packing cover, and a plurality of organic light emitting units. The carrier plate and the packing cover are assembled together to form a sealed space, and the organic light emitting units are disposed on the carrier plate and located inside in the sealed space. The cover plate is adhered at a side of the carrier plate away from the organic light emitting units. The touch sensing element is disposed between the carrier plate of the organic electro-luminescent display panel and the cover plate. The decoration layer is disposed on the cover plate.

In view of the above, a touch sensing element is disposed on the cover plate having a decoration layer according to the invention and such cover plate is adhered with the organic electro-luminescent display panel. Accordingly, the touch display panel does not require the thickness largely increased to having both the display function and the touch sensing function.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic cross-sectional view of a touch display panel according to a first embodiment of the present invention.

FIG. 2 is a schematic top view of a first type of a touch sensing element.

FIG. 3 is a schematic top view of a second type of a touch sensing element.

FIG. 4 is a schematic cross-sectional view of the touch sensing element taken along a sectional line A-A′ depicted in FIG. 3.

FIG. 5 is a schematic top view of a third type of a touch sensing element.

FIG. 6 is a schematic cross-sectional view of the touch sensing element taken along a sectional line B-B′ depicted in FIG. 5.

FIG. 7 is a schematic top view of a fourth type of a touch sensing element.

FIG. 8 is a schematic cross-sectional view of the touch sensing element taken along a sectional line C-C′ depicted in FIG. 7.

FIG. 9 is a schematic top view of a fifth type of a touch sensing element.

FIG. 10 is a schematic cross-sectional view of the touch sensing element taken along a sectional line D-D′ depicted in FIG. 9.

FIG. 11 is a schematic cross-sectional view of a touch display panel according to a second embodiment of the present invention.

FIG. 12 is a schematic cross-sectional view of a touch display panel according to a third embodiment of the present invention.

FIG. 13 is a schematic cross-sectional view of a touch display panel according to a fourth embodiment of the present invention.

FIG. 14 is a schematic cross-sectional view of a touch display panel according to a fifth embodiment of the present invention.

FIG. 15 is a schematic cross-sectional view of a touch display panel according to a sixth embodiment of the present invention.

FIG. 16 is a schematic partial top view of the touch display panel depicted in FIG. 15.

FIG. 17 is a schematic cross-sectional view of a touch display panel according to a seventh embodiment of the present invention.

FIG. 18 is a schematic top view illustrating the active device array of the organic electro-luminescent display panel and the touch sensing element in the touch display panel of FIG. 17.

FIG. 19 is a schematic top view illustrating the active device array of the organic electro-luminescent display panel and the touch sensing element in the touch display panel of FIG. 17 according to another embodiment.

### DESCRIPTION OF EMBODIMENTS

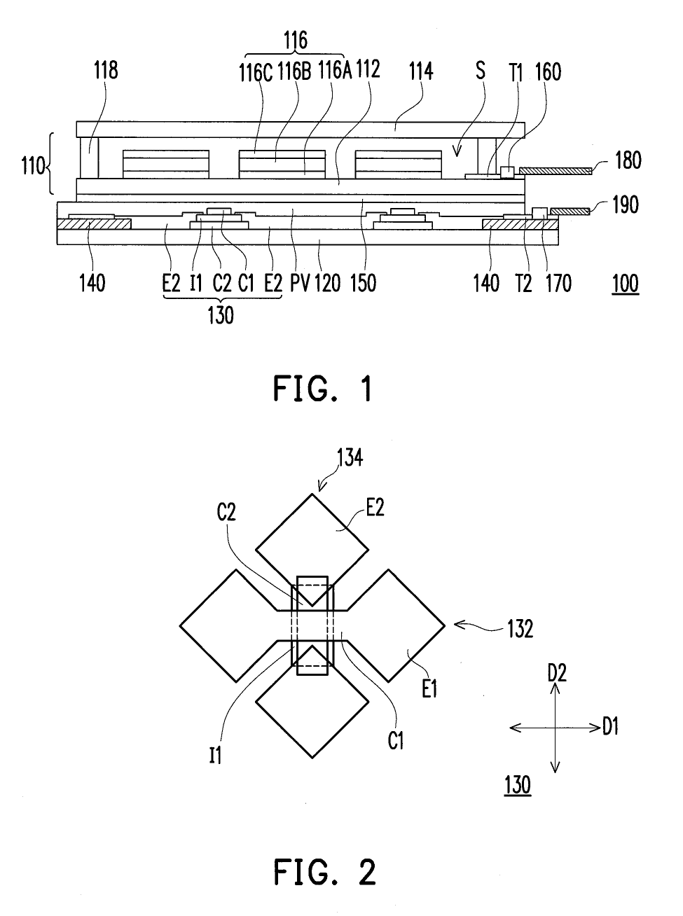

FIG. 1 is a schematic cross-sectional view of a touch display panel according to a first embodiment of the present invention. Referring to FIG. 1, a touch display panel 100 includes an organic electro-luminescent display panel 110, a cover plate 120, a touch sensing element 130, and a decoration layer 140. The organic electro-luminescent display panel 110 includes a carrier plate 112, a packing cover 114, and a plurality of organic light emitting units 116. The carrier plate 112 and the packing cover 114 are assembled together to form a sealed space S, and the organic light emitting units 116 are disposed on the carrier plate 114 and located in the sealed space S. The cover plate 120 is adhered at a side of the carrier plate 112 away from the organic light emitting units 116. The touch sensing element 130 such as a capacitive touch sensing element is disposed on the cover plate 120 and the decoration layer 140 is disposed on the periphery of the cover plate 120.

In the present embodiment, the carrier plate 112 is a transparent plate and the packing cover 114 is connected to the carrier plate 112 through a sealant 118 to form the sealed space S, wherein the sealed space S can be filled with an inert gas or with transparent filler. Each of the organic light emitting units 116 includes a first electrode 116A, a light emitting layer 116B, and a second electrode 116C which are sequentially stacked on the carrier plate 112. In other words, the first electrode 116A is located between the carrier plate 112 and the light emitting layer 116B and the second electrode 116C is located at a side of the light emitting layer 116B away from the first electrode 116A. In addition, the first electrode 116A can, for example, be a transparent electrode while the second electrode 116 C is exemplarily a reflective electrode such that the organic light emitting units 116 are the bottom emission type organic light emitting units. The display light of organic electro-luminescent display panel 110 passes through the carrier plate 112 and the cover plate 120 sequentially and then is obtained by the user.

The cover plate 120 can be a glass carrier plate or a plastic carrier plate on which the decoration layer 140 is disposed for shielding the lines, such as the transmission lines T1 of the organic electro-luminescent display panel 100 and the transmission lines T2 of the touch sensing element 130, located at the periphery of the touch display panel 100 or for forming the decoration patterns. A material of the decoration layer 140 can be ink, ceramic material, diamond-like carbon, photo-resist material, or the like. In the present embodiment, the decoration layer 140 and the touch sensing element 130 are disposed at the same side of the cover plate 120, but this should by no means to be construed as a limitation of the invention. In addition, the touch sensing element 130, for example, is covered by a passivation layer PV and an adhesion layer 150 is disposed between the passivation layer PV and the carrier plate 112 so that the organic electro-luminescent display panel 100 and the cover plate 150 are adhered together. The adhesion layer 150 can be formed by a liquid optical glue applied on the whole surface of the cover plate 120 and subsequently cured thereon, a solid optical glue adhered on the cover plate 120, or a ring shape glue configured surrounding the touch sensing element 130.

Specifically, the touch display panel 100 can further include driving chips 160 and 170 and flexible circuit boards 180 and 190 for achieving performing each function. The organic light emitting units 116 and the touch sensing element 130 can be electrically connected to the driving chip 160 and the driving chip 170 through the transmission line T1 and the transmission line T2, respectively, and the flexible circuit boards 180 and 190 can be used for electrically connecting the driving chips 160 and 170 to an external element, respectively. Furthermore, the driving chips 160 and 170 can be disposed on the carrier plate 112 and the cover plate 120 by a way of chip on glass (COG). However, the invention is not limited thereto. According to other embodiments of the invention, the driving chips 160 and 170 can be disposed on the flexible circuit boards 180 and 190 or be disposed by another way. In the present embodiment, no other carrier substrate is disposed between the cover plate 120 and the organic electro-luminescent display pane 110 so that the thickness of the touch display panel 100 is not significantly increased owing to the additional disposition of the elements for touch sensing function. Accordingly, the touch display panel 100 can have both the display function and the touch sensing function without large thickness.

More specifically, FIG. 2 is a schematic top view of a first type of a touch sensing element. As shown in FIG. 1 and FIG. 2, the touch sensing element 130 of this embodiment is consisted of a plurality of first sensing series 132 parallel to one another and a plurality of second sensing series 134 parallel to one another, wherein merely a part thereof is shown in FIG. 2 for clearly illustrating the design of the touch sensing element. The first sensing series 132 and the second sensing series 134 respectively extend in a first direction D1 and a second direction D2. The first direction D1 intersects the second direction D2.

The first sensing series 132 includes, for example, a plurality of first sensing electrodes E1 and a plurality of first bridge electrodes C1 serially connected the first sensing electrodes E1. The second sensing series 134 includes, for example, a plurality of second sensing electrodes E2 and a plurality of second bridge electrodes C2 serially connected the second sensing electrodes E2. The shapes of the first sensing electrodes E1 and the second sensing electrodes E2 are not limited to the diamond shape illustrated in the drawing of FIG. 2 and can be other shapes such as other polygon. As shown in FIG. 1, the second bridge electrode C2 is disposed on the cover plate 120 and an insulation pattern I1 is configured between the second bridge electrode C2 and the first bridge electrode C1 so that the first bridge electrode C1 is electrically insulated from the second bridge electrode C2, wherein the insulation pattern I1 can have an island pattern. In the present embodiment, the first sensing electrodes E1 and the second sensing electrodes E2 are disposed on the same surface which is the surface of the cover plate 120. Nevertheless, the invention is not limited thereto. In an alternate embodiment, an insulation layer (SiO₂ layer) can be coated on the surface of the cover plate 120 prior to the disposition of the first sensing electrodes E1 and the second sensing electrodes E2 so that the first sensing electrodes E1 and the second sensing electrodes E2 can be disposed on said insulation layer.

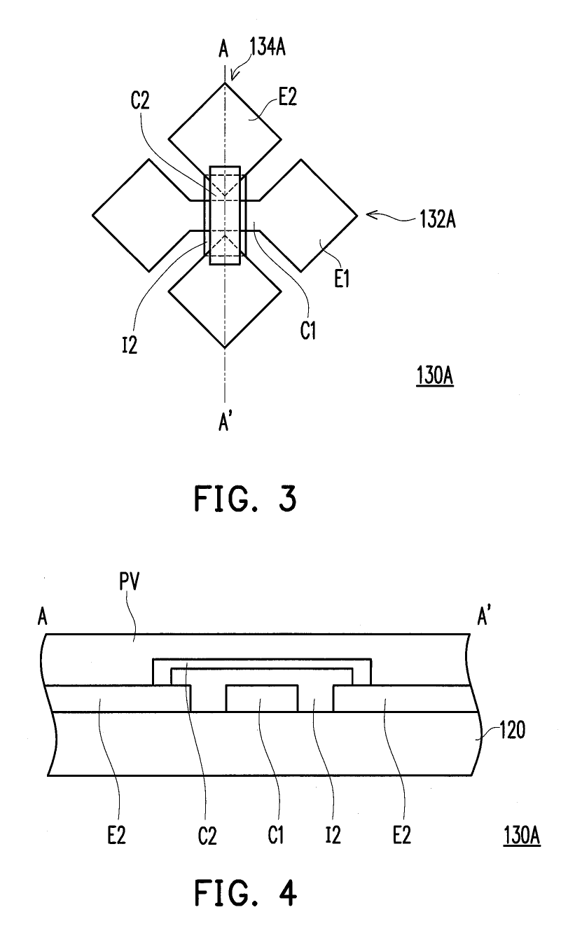

FIG. 3 is a schematic top view of a second type of a touch sensing element and FIG. 4 is a schematic cross-sectional view of the touch sensing element taken along a sectional line A-A′ depicted in FIG. 3. With reference to FIG. 3 and FIG. 4, the components of the touch sensing element 130A are the same as those of the touch sensing element 130 mentioned above and thus the same reference numbers refer to the same components in the two examples. Specifically, the fabrication of the touch sensing element 130A is different from that of the touch sensing element 130.

In the touch sensing element 130A, the first bridge electrode C1 is located between the insulation pattern I2 and the cover plate 120 and the second bridge electrode C2 is located at a side of the insulation pattern I2 away from the cover plate 120. In other words, according to the present embodiment, the first sensing series 132A and the second sensing electrodes E2 are first fabricated. Next, the insulation pattern I2 is formed on the first bridge electrode C1 of the first sensing series 132A and the insulation pattern I2 can be an island pattern. Afterwards, the second bridge electrode C2 is formed on the insulation pattern I2 for serially connecting the second sensing electrodes E2 into the second sensing series 132B.

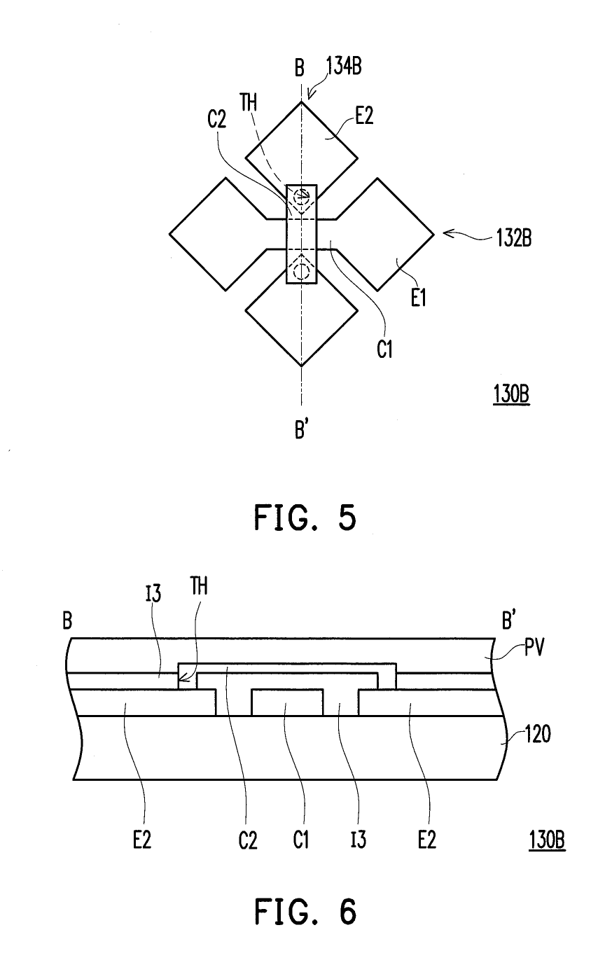

FIG. 5 is a schematic top view of a third type of a touch sensing element and FIG. 6 is a schematic cross-sectional view of the touch sensing element taken along a sectional line B-B′ depicted in FIG. 5. With reference to FIG. 5 and FIG. 6, the components of the touch sensing element 130B are the same as those of the touch sensing element 130A mentioned above and thus the same reference numbers refer to the same components in the two touch sensing elements 130A and 130B. Specifically, the difference between the touch sensing element 130B and the touch sensing element 130A lines in that an insulation layer I3 is used for replacing the insulation pattern I2 of the touch sensing element 130A according to the touch sensing element 130B. The insulation layer I3 covers the first sensing series 132B and the second sensing electrodes E2 of the second sensing series 134B and the second bridge electrode C2 of the second sensing series 134B is disposed on the insulation layer I3. Besides, the insulation layer I3 has a plurality of through holes TH so that the second bridge electrode C2 can be electrically connected to the second sensing electrodes E2 through the through holes TH.

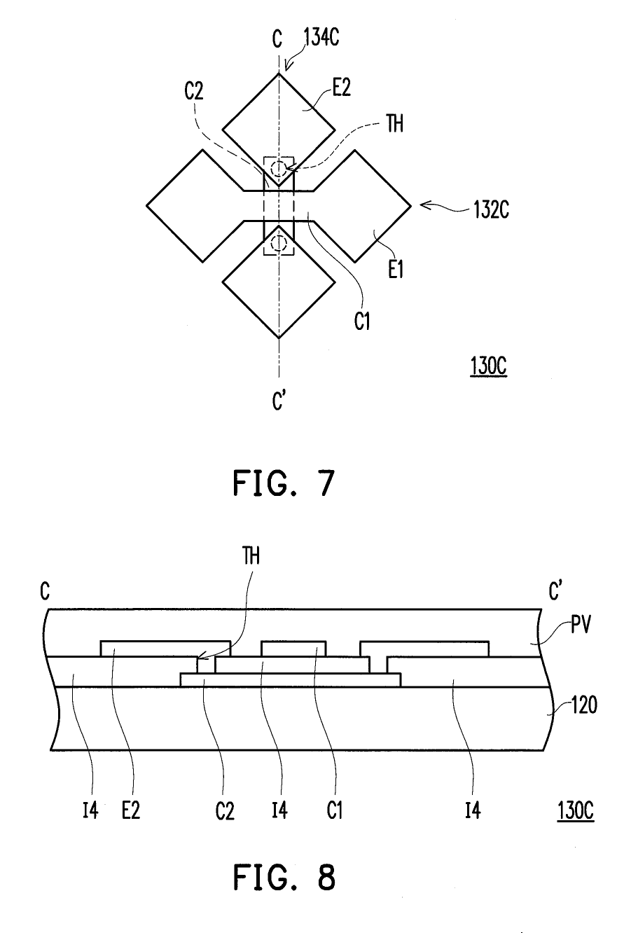

FIG. 7 is a schematic top view of a fourth type of a touch sensing element and FIG. 8 is a schematic cross-sectional view of the touch sensing element taken along a sectional line C-C′ depicted in FIG. 7. With reference to FIG. 7 and FIG. 8, the components of the touch sensing element 130C are the same as those of the touch sensing element 130B mentioned above and thus the same reference numbers refer to the same components in the two examples. The difference between the touch sensing element 130C and the touch sensing element 130B lies in that the second bridge electrode C2 of the second sensing series 134C is disposed at a side of the insulation layer 14 adjacent to the cover plate 120 in the touch sensing element 130C. Specifically, the fabrication of the touch sensing element 130C is different from that of the touch sensing element 130B. In the present embodiment, the first sensing series 132C and the second sensing electrodes E2 of the second sensing series 134C are simultaneously disposed on the insulation layer I4. Besides, the insulation layer I4 has a plurality of through holes TH so that the second sensing electrodes E2 can be electrically connected to the second bridge electrode C2 through the through holes TH to form the second sensing series 134C.

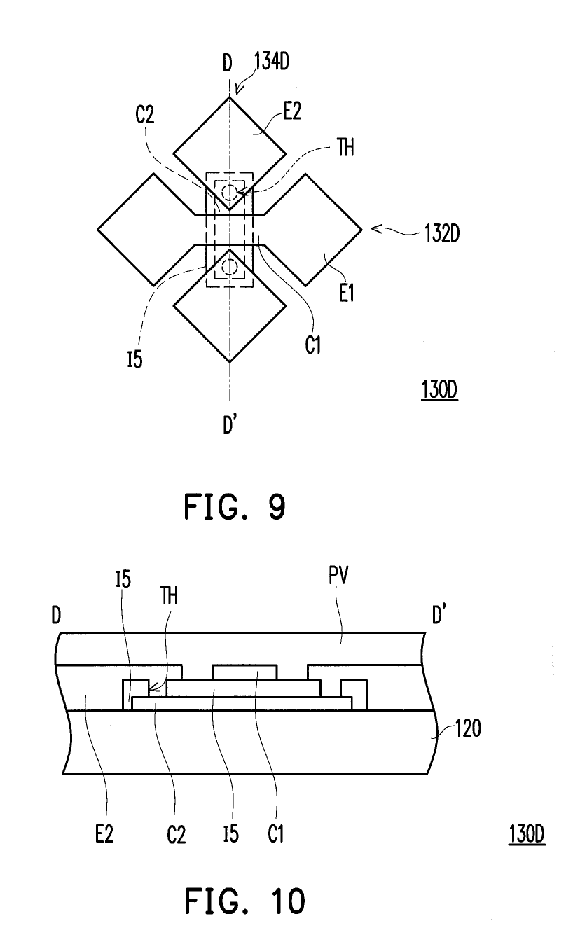

FIG. 9 is a schematic top view of a fifth type of a touch sensing element and FIG. 10 is a schematic cross-sectional view of the touch sensing element taken along a sectional line D-D′ depicted in FIG. 9. With reference to FIG. 9 and FIG. 10, the components of the touch sensing element 130D are the same as those of the touch sensing element 130 mentioned above and thus the same reference numbers refer to the same components in the two examples. The difference between the touch sensing element 130D and the touch sensing element 130 lies in that the island shaped insulation pattern 15 in the touch sensing element 130D completely covers the second bridge electrode C2 of the second sensing series 134D in addition to where the through holes TH are, and the first bridge electrode C1 of the first sensing series 132D is configured at a side of the insulation pattern I5 away from the cover plate 120. In other words, the insulation layer I5 has a plurality of through holes TH respectively exposing two ends of each second bridge electrode C2 and the second sensing electrodes E2 can be electrically connected to the second bridge electrode C2 through the through holes TH to form the second sensing series 134D.

The fifth type design of the touch sensing element substantially combines the characteristics of the first type and the fourth type of the touch sensing elements, wherein the second bridge electrode C2 is completely covered by the insulation pattern I5 such that the etchant for patterning the first sensing electrodes E1 and the second sensing electrodes E2 is prevented from permeating from the edge of the insulation pattern I5 to damage the second bridge electrode C2, which further improves the quality of the first type of the touch sensing element. On the contrary, merely a part of the second bridge electrode C2 is covered by the insulation pattern I1 in the abovementioned first type of the touch sensing element as shown in FIG. 2 such that the etchant for patterning the first sensing electrodes E1 and the second sensing electrodes E2 may permeate from the edge of the insulation pattern I5 to damage the second bridge electrode C2. Furthermore, the insulation pattern I5 configured in the fifth type of the touch sensing element is merely located at the bridge portion rather than a complete insulation layer I4 as shown in the fourth type of the touch sensing element so that the area constructed by the insulation pattern I5 overlapping the adjacent sensing electrodes E1 and E2 is smaller than 40% of the area of one second sensing electrode E2, which is conducive to enhance the light transparency at the region where the first sensing electrodes E1 and the second sensing electrodes E2 are located and is conducive to reduce the loss of the light from the organic electro-luminescent display panel to the extent of 1% to 2%. In addition, when the insulation layer I4 completely formed on the surface of the substrate is an organic layer, the total touch display panel may present certain color such as yellow rather than colorless, which may have influence on the display quality of the touch display panel. Accordingly, it may be preferably to omit the completely formed insulation layer I4. In the present embodiment, a material of the second bridge electrode C2 may be metal, transparent conductive material, or the stack of the two materials.

The touch sensing elements 130A˜130D may be applied to replace the touch sensing element 130 of the touch display panel 100 depicted in FIG. 1 for providing the required touch sensing function. On the other hand, the descriptions of the touch sensing elements 130, 130A˜130D are not intents to limit the scope of the invention. A designer can adopt other type of the touch sensing element configured in the touch display panel 100 for providing the touch sensing function. For example, the sensing electrodes can be configured by the same layer without the disposition of the bridge electrodes, or the shapes of the sensing electrodes can be rectangles, triangles, and the like.

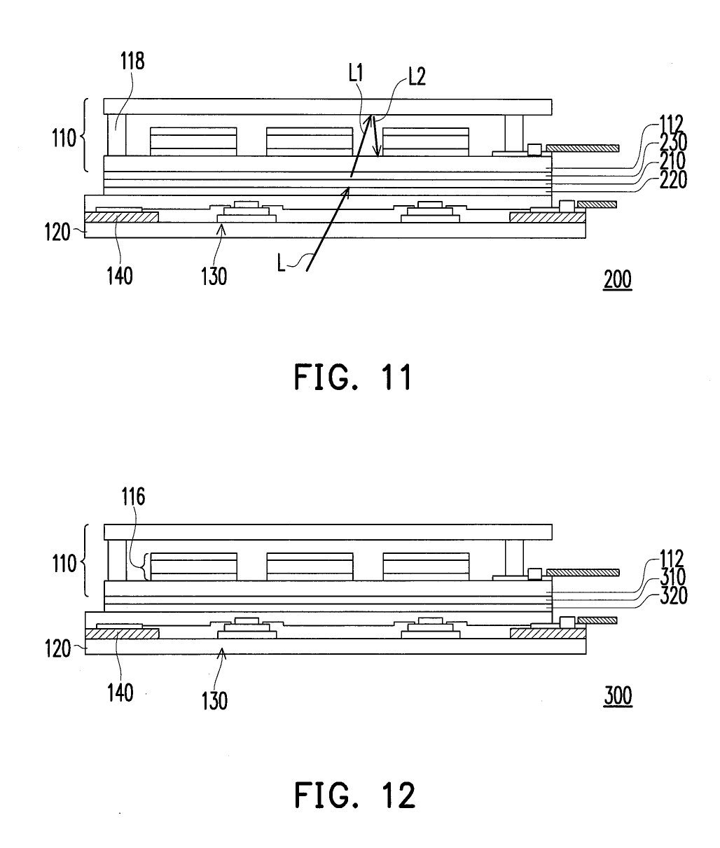

FIG. 11 is a schematic cross-sectional view of a touch display panel according to a second embodiment of the present invention. With reference to FIG. 11, the touch display panel 200 is substantially the same as the touch display panel 100, and therefore the reference numbers of the components in the touch display panel 200 can be referred to as the reference numbers described in the first embodiment. In the present embodiment, the touch display panel 200 further includes a circular polarizer 210 located between the organic electro-luminescent display panel 110 and the touch sensing element 130. Specifically, an adhesion layer 220 is used in the present embodiment for adhering a side of the circular polarizer 210 on the touch sensing element 130 and another adhesion layer 230 is used for adhering another side of the circular polarizer 210 on the carrier plate 112 of the organic-luminescent display panel 110.

The circular polarizer 210 is conducive to prevent the external light reflected by the organic electro-luminescent display panel 100 from emitting outward from the touch display panel 100. In detail, the external light L passing through the circular polarizer 210 can be transformed into a first circular polarized light L1. The first polarized light L1 entering the organic electro-luminescent display panel 100 can be reflected at the interfaces between the components of the organic electro-luminescent display panel 100. The reflected light L2 having the phase substantially opposite to that of the first circular polarized light L1 can not pass the circular polarizer 210. Accordingly, the reflected light L2 is not liable to be received by the user when the image is displayed by the touch display panel 200. In other words, the displayed image is not interfered by the reflected light L2 and has desirable quality.

FIG. 12 is a schematic cross-sectional view of a touch display panel according to a third embodiment of the present invention. With reference to FIG. 12, the touch display panel 300 is substantially the same as the touch display panel 100 according to the first embodiment, and therefore the reference numbers of the components in the touch display panel 300 can be referred to as the reference numbers described in the first embodiment. In the present embodiment, the touch display panel 300 further includes a shielding layer 310 located between the organic electro-luminescent display panel 110 and the touch sensing element 130. According to this embodiment, the shielding layer 310 is formed on the carrier plate 112 of the organic electro-luminescent display panel 110. In addition, an adhesion layer 320 is used for adhering the shielding layer 310 and the touch sensing element 130. The shielding layer 310 can be a conductive layer completely formed on the whole surface of the substrate, which prevents from the electromagnetic interference (EMI) between the touch sensing element 130 and the organic light emitting units 116.

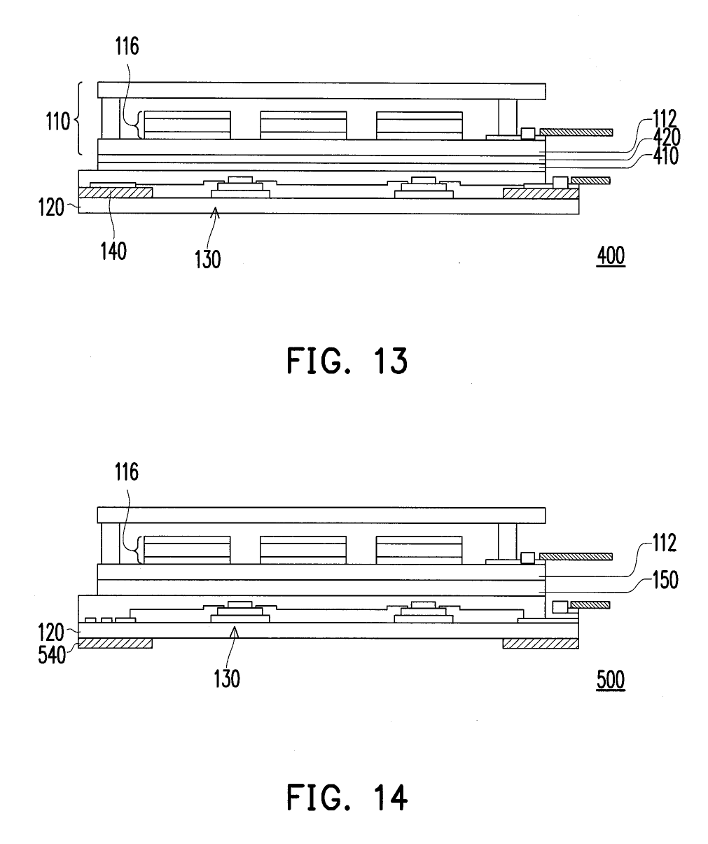

FIG. 13 is a schematic cross-sectional view of a touch display panel according to a fourth embodiment of the present invention. With reference to FIG. 13, the touch display panel 400 is substantially the same as the touch display panel 300 according to the third embodiment, and therefore the reference numbers of the components in the touch display panel 400 can be referred to as the reference numbers described in the third embodiment. According to this embodiment, the shielding layer 410 of the touch display panel 400 is formed directly on the touch sensing element 130. In addition, an adhesion layer 420 is used for adhering the shielding layer 310 and the carrier plate 112. Namely, the adhesion layer 420 is located between the shielding layer 310 and the carrier plate 112. The shielding layer 410 can be a conductive layer completely formed on the whole surface of the substrate, a ring-shaped conductive layer, or a network-like conductive layer, which prevents from the EMI between the touch sensing element 130 and the organic light emitting units 116.

Furthermore, FIG. 14 is a schematic cross-sectional view of a touch display panel according to a fifth embodiment of the present invention. With reference to FIG. 14, the touch display panel 500 is substantially the same as the touch display panel 100 according to the first embodiment, and therefore the reference numbers of the components in the touch display panel 500 can be referred to as the reference numbers described in the first embodiment. In the present embodiment, the decoration layer 540 is disposed at a side of the cover plate 120 away from the touch sensing element 130. Accordingly, the touch sensing element 130 and the decoration layer 540 are respectively disposed at opposite sides of the cover plate 120. It is noted that the decoration layer 540 can be fabricated by ceramic material, diamond-like carbon, or other materials, and the decoration layer 540 has a thin thickness without constructing an obvious protruding structure on the cover plate 120. Therefore, the user can feel smooth when touching the cover plate 120.

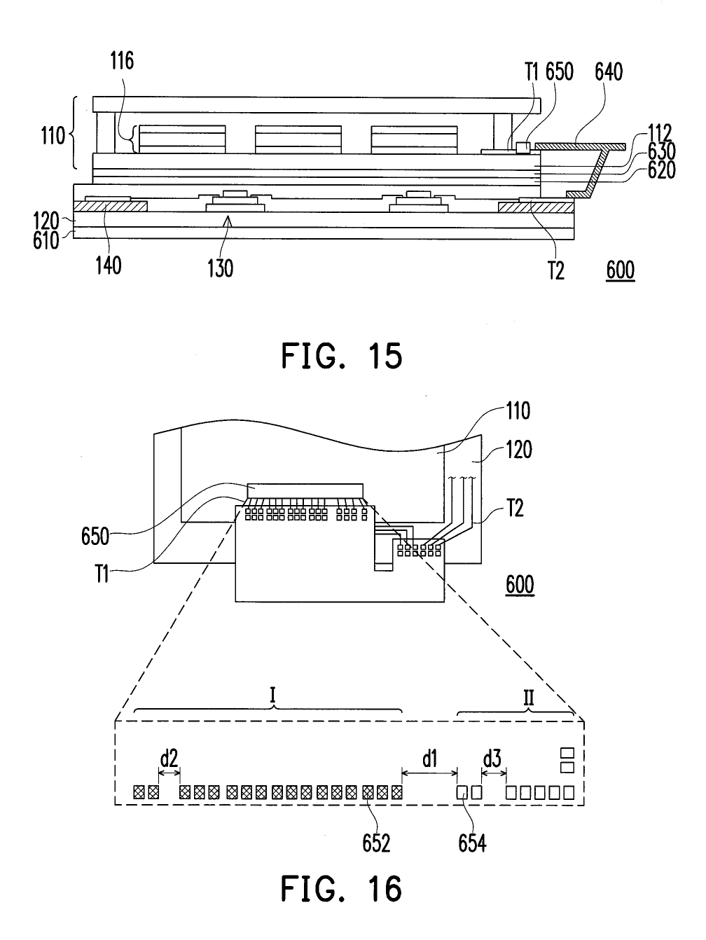

FIG. 15 is a schematic cross-sectional view of a touch display panel according to a sixth embodiment of the present invention and FIG. 16 is a schematic partial top view of the touch display panel depicted in FIG. 15. With reference to FIG. 15, the touch display panel 600 is substantially the same as the touch display panel 100 according to the first embodiment, and therefore the reference numbers of the components in the touch display panel 600 can be referred to as the reference numbers described in the first embodiment. In addition to all the components of the touch display panel 100, the touch display panel 600 further includes a circular polarizer 610 and a shielding layer 620. The circular polarizer 610 is disposed at a side of the cover plate 120 away from the touch sensing element 130. The shielding layer 630 is formed on the touch sensing element 130 and adhered on the organic electro-luminescent display panel 110 through the adhesion layer 630. Alternately, the shielding layer 620 can be selectively fabricated on the organic electro-luminescent display panel 110 or on the touch sensing element 130.

Furthermore, the touch display panel 600 can further includes a flexible circuit board 640 and a driving chip 650. The flexible circuit board 640 is simultaneously electrically connected to the organic light emitting units 116 and the touch sensing element 130, and the driving chip 650 is electrically connected to the organic light emitting units 116 and the touch sensing element 130 through the flexible circuit board 640. That is to say, the driving chip 650 having multi-functions can be used in the present embodiment so as to drive the organic light emitting units 116 and the touch sensing elements 130 simultaneously. Accordingly, the number of the flexible circuit board 640 connected between the organic electro-luminescent display panel 110 and the touch sensing element 130 is only one rather than two or more used in the present embodiment.

Referring to FIG. 15 and FIG. 16 together, the driving chip 650 can have a plurality of first leads 652 and a plurality of second leads 654 for performing multiple functions. The first leads 652 are electrically connected to the organic light emitting units 116 of the organic electro-luminescent display panel 110 and the second leads 654 are electrically connected to the touch sensing element 130. In this embodiment, a first connecting region I is defined by the first leads 652 and a second connecting region II is defined by the second leads 654. The distance d1 between the first connecting region I and the second connecting region II is, for example, greater than the distance d2 between two adjacent first leads 652 and the distance d3 between two adjacent second leads 654. Accordingly, the first connecting region I and the second connecting region II are distinguishable for correctly assembling the driving chip 650 on the touch display panel 600. In addition, the carrier plate 112 can be disposed with the pads corresponding to the first leads 652 and the second leads 654 of the driving chip 650.

Specifically, the driving chips 650 can be disposed on the carrier plate 112 by a way of chip on glass (COG). Nevertheless, in an alternate embodiment, the driving chips 650 can be disposed on the cover plate 120 by the way of chip on glass (COG). Furthermore, the driving chip 650 can be selectively disposed on the flexible circuit board 640 or on other external electronic device.

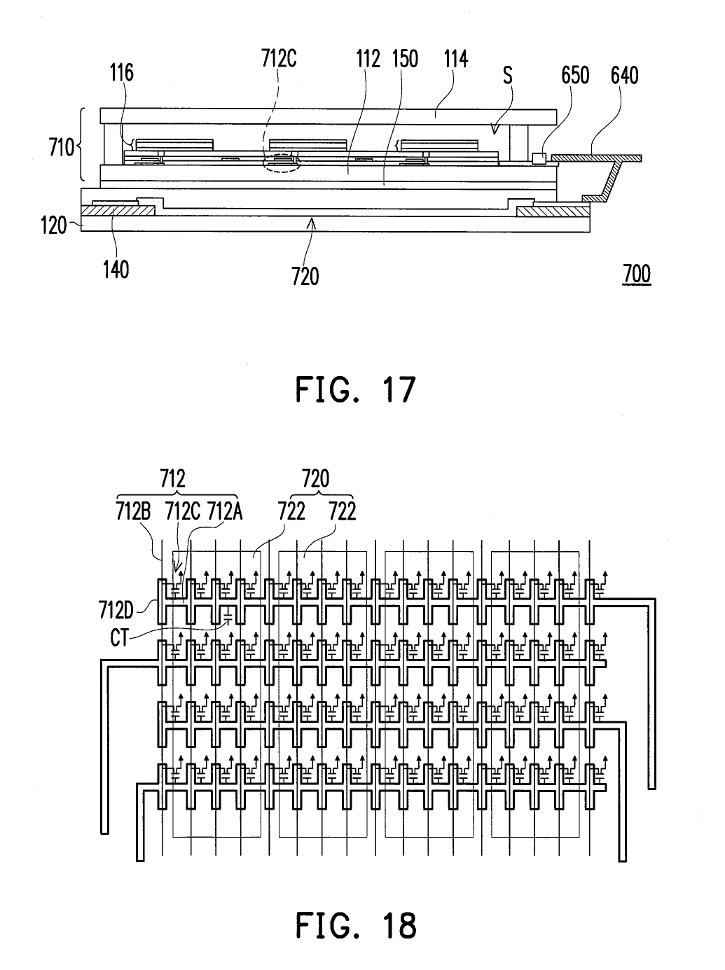

FIG. 17 is a schematic cross-sectional view of a touch display panel according to a seventh embodiment of the present invention and FIG. 18 is a schematic top view illustrating the active device array of the organic electro-luminescent display panel and the touch sensing element in the touch display panel of FIG. 17. Referring to FIG. 17 and FIG. 18 together, a touch display panel 700 includes an organic electro-luminescent display panel 710, a cover plate 120, a touch sensing element 720, and a decoration layer 140. The organic electro-luminescent display panel 710 includes a carrier plate 112, a packing cover 114, a plurality of organic light emitting units 116, and an active device array 712. The carrier plate 112 and the packing cover 114 are assembled together to form a sealed space S, and the organic light emitting units 116 are disposed on the carrier plate 112 and located inside in the sealed space S. The active device array 712 is, for instance, electrically connected to the organic light emitting units 116. The cover plate 120 is adhered at a side of the carrier plate 112 away from the organic light emitting units 116. The touch sensing element 720 is disposed between the carrier plate 112 of the organic electro-luminescent display panel 710 and the cover plate 120. The decoration layer 140 is disposed on the cover plate 120.

Specifically, the organic electro-luminescent display panel 710 according to the present embodiment is an active type organic electro-luminescent display. The active device array 712 includes a plurality of scan lines 712A, a plurality of data lines 712B, and a plurality of active devices 712C. The scan lines 712A intersect the data lines 712B, and each active device 712C is connected to the corresponding scan line 712A, the corresponding data line 712B, and the corresponding organic light emitting unit 116. Furthermore, the touch sensing element 720 includes a plurality of sensing electrodes 722 parallel to the data lines 712B and a touch sensing capacitance CT is formed between the sensing electrodes 722 and the scan lines 712A. Specifically, the scan lines 712A of the organic electro-luminescent display panel 710 are served as the scan lines for the touch sensing function. Here, the touch sensing element 720 can be achieved by the sensing electrodes 722 patterned from one single conductive layer.

For the enhancement of the touch sensing capacitance CT, the active device array 712 can further include a plurality of coupling patterns 712D connected to the scan lines 712A. According to this embodiment, the coupling patterns 712D can overlap the data lines 712B to reduce the coupling effect between the coupling patterns 712D and the organic light emitting units 116. As such, the organic light emitting units 116 can have satisfactory display effect. In addition, in the present embodiment, the scan lines 712A are connected with the coupling patterns 712D and the scan lines 712A are served as the scan lines of the display function and the scan lines of the touch sensing function. It is for sure that the invention should not be construed as limited to the embodiments described above.

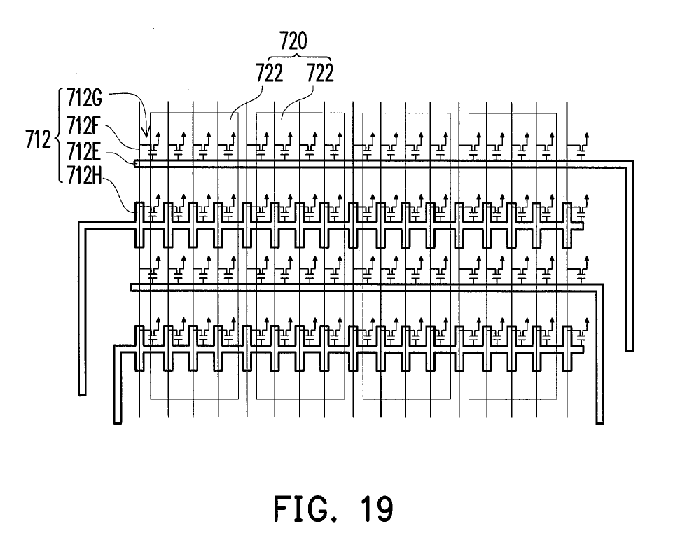

FIG. 19 is a schematic top view illustrating the active device array of the organic electro-luminescent display panel and the touch sensing element in the touch display panel of FIG. 17 according to another embodiment. Referring to FIG. 17 and FIG. 19, the active device array 712 includes a plurality of scan lines 712E, a plurality of data lines 712F, and a plurality of active devices 712G. The scan lines 712E intersect the data lines 712F, and each active device 712G is connected to the corresponding scan line 712E, the corresponding data line 712F, and the corresponding organic light emitting unit 116. Furthermore, the touch sensing element 720 includes a plurality of sensing electrodes 722 parallel to the data lines 712F and a touch sensing capacitance CT is formed between the sensing electrodes 722 and the scan lines 712E. Specifically, merely a portion of the scan lines 712E is served as the scan lines for both of the display function and the touch sensing function. Hence, the coupling patterns 712H are disposed on a portion of the scan lines 712E.

In an exemplary example, the odd scan lines 712E are served as the scan lines only for the display function and are not connected with the coupling patterns 712H. The even scan lines 712E are served as the scan lines for both the display function and the touch sensing function and are connected with the coupling patterns 712H. In other words, the touch display panel 700 does not require each of the scan lines 712E to be applied in both functions. According to the required resolution, merely a portion of the scan lines 712E is served as the scan lines for both of the display function and the touch sensing function while the other portion of the scan lines 712E is only used as the scan lines for display function.

In view of the forgoing, a touch sensing element is disposed on the cover plate having a decoration layer according to the invention and such cover plate is adhered with the organic electro-luminescent display panel. The touch sensing elements can be formed by the sensing electrodes patterned from one single conductive layer as those disclosed in the U.S. Pat. No. 4,187,625 or U.S. Pat. No. 4,954,823, in addition to the structures depicted in the foregoing embodiments. As such, the sensing electrodes can be fabricated by the same process and two adjacent sensing electrodes are electrically unconnected with each other. Accordingly, the touch display panel does not require the thickness largely increased to having both the display function and the touch sensing function, and has highly utility. Furthermore, the cover plate in the embodiments can be plastic substrate and the sensing electrodes can be fabricated by printing process for simplifying the fabrication of the touch display panel and reducing the fabrication cost.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display panel, comprising:
a cover plate comprising a touch sensing element and a decoration layer, the decoration layer being located at a periphery of a surface of the cover plate;
an organic electro-luminescent display panel comprising a carrier plate, a packing cover, and a plurality of bottom emission type organic light emitting unit, the carrier plate and the packing cover being assembled together to form a sealed space, the organic light emitting units being disposed on the carrier plate and located inside the sealed space; and
an adhesion layer, the cover plate being adhered on the carrier plate through the adhesion layer.

2. The touch display panel as claimed in claim 1, further comprising a circular polarizer adhered between the carrier plate of the organic electro-luminescent display panel and the cover plate.

3. The touch display panel as claimed in claim 1, further comprising a shielding layer located between the carrier plate of the organic electro-luminescent display panel and the touch sensing element.

4. The touch display panel as claimed in claim 1, further comprising a driving chip and a flexible circuit board, the flexible circuit board being electrically connected to both of the organic light emitting units and the touch sensing element, and the driving chip being electrically connected to the organic light emitting units and the touch sensing element through the flexible circuit board.

5. The touch display panel as claimed in claim 4, wherein the driving chip has a plurality of first leads and a plurality of second leads, the first leads are electrically connected to the organic light emitting units, the second leads are electrically connected to the touch sensing element, a first connecting region is defined by the first leads, a second connecting region is defined by the second leads, and a distance between the first connecting region and the second connecting region is larger than a distance between any two adjacent first leads and larger than a distance between any two adjacent second leads.

6. The touch display panel as claimed in claim 1, wherein the organic electro-luminescent display panel further comprises an active device array disposed on the carrier plate and electrically connected to the organic light emitting units and the active device array comprises a plurality of scan lines, a plurality of data lines, and a plurality of active devices, wherein the scan lines are intersected with the data lines, each of the active devices electrically connected to a corresponding scan line, a corresponding data line, and a corresponding organic light emitting diode.

7. The touch display panel as claimed in claim 6, wherein the active device array further comprises a plurality of coupling patterns connected to the scan lines and overlapping the data lines.

8. The touch display panel as claimed in claim 6, wherein the touch sensing element comprises a plurality of sensing electrodes parallel to the data lines and a touch sensing capacitance is formed between the sensing electrodes and the scan lines.

9. The touch display panel as claimed in claim 1, wherein the touch sensing element comprises a plurality of first sensing series and a plurality of second sensing series, the first sensing series extend in a first direction, the second sensing series extend in a second direction and are separated from the first sensing series spatially, and the first direction intersects the second direction.

10. The touch display panel as claimed in claim 9, wherein each of the first sensing series comprises a plurality of first sensing electrodes and a plurality of first bridge electrodes electrically connecting the first sensing electrodes, each of the second sensing series comprises a plurality of second sensing electrodes and a plurality of second bridge electrodes electrically connecting the second sensing electrodes, each of the second bridge electrodes is electrically insulated from a corresponding first bridge electrode through an insulation pattern, the insulation pattern has through holes respectively located at two ends of the insulation pattern such that each of the second bridge electrode is electrically connected to two adjacent second sensing electrodes, and a total area constructed by overlapping of the insulation pattern and the two adjacent second sensing electrodes is smaller than 40% of an area of one second sensing electrode.

11. The touch display panel as claimed in claim 1, wherein the touch sensing element comprises a plurality of sensing electrodes formed by a same process, and two adjacent sensing electrodes are electrically unconnected with each other.

12. The touch display panel as claimed in claim 11, wherein the cover plate is a plastic substrate and the sensing electrodes are formed by a printing process.

13. The touch display panel as claimed in claim 1, wherein the decoration layer is disposed on a side of the cover plate away from the touch sensing element.
